(19) United States
(12) Patent Application Publication
(10) Pub. No.: US 2026/0218992 A1
(43) Pub. Date: Jul. 30, 2026

(54) HEAT EXCHANGER AND METHOD FOR OPERATING A HEAT EXCHANGER

(71) Applicant: HUBER SE, Berching (DE)

(72) Inventors: Christian FROMMANN, Berching (DE); Johannes DOMMER, Berngau (DE)

(21) Appl. No.: 19/459,420

(22) Filed: Jan. 26, 2026

(30) Foreign Application Priority Data
Jan. 28, 2025 (DE) 10 2025 102 973.3

(51) Int. Cl. F28D 21/00

(52) U.S. Cl. CPC F28D 21/00; F28D 2021/0098

(57) ABSTRACT

In one aspect, a heat exchanger for a liquid medium includes a first chamber for receiving a liquid medium and a first heat exchanger arrangement arranged in the first chamber. Furthermore, the heat exchanger includes a second chamber for receiving a liquid medium, a second heat exchanger arrangement arranged in the second chamber, and a first pre-screening device.

### CROSS-REFERENCE TO RELATED APPLICATIONS

The present application is based upon and claims the right of priority to German Patent Application No. 10 2025 102 973.3, filed Jan. 28, 2025, the disclosure of which is hereby incorporated by reference herein in its entirety for all purposes.

### FIELD OF THE INVENTION

The present subject matter relates to a heat exchanger for a liquid medium, having a first chamber for receiving a liquid medium and a first heat exchanger arrangement arranged in the first chamber. The present subject matter also relates to a method for operating a heat exchanger.

### BACKGROUND OF THE INVENTION

Heat exchangers of this type are sufficiently known and are used, for example, to recover a portion of the residual heat contained in a liquid medium. The liquid medium in this case can be, for example, wastewater, sewage sludge, or surface water. The liquid medium is introduced into the first chamber of the heat exchanger and, there, can transfer a portion of its heat to the first heat exchanger arrangement arranged in the first chamber. A heat transfer medium, for example, flows through the first heat exchanger arrangement, which heat transfer medium absorbs the heat and makes this available for further uses. The heat transfer can, in principle, take place in both directions. As a result, the heat can be used, for example, for heating or cooling purposes or as process heat. A heat exchanger of this type is known, for example, from DE 10 2008 001 518 A1.

A problem that arises with wastewater or sewage sludge in this context is soiling of the heat exchanger by solid components, or suspended solids, contained in these media. In particular, coarse debris and foreign objects can cause the heat exchanger to become clogged, making it necessary to perform costly maintenance on the heat exchanger. In addition, there is a constant need to design such heat exchangers to be more compact and more efficient, such that they can be economically used, for example, not only in sewage treatment plants, but also in individual, in particular commercial, buildings. In particular in the latter intended use, flexible adaptability of the heat exchanger to different performance requirements is also of particular importance.

### SUMMARY OF THE INVENTION

The problem addressed by the present subject matter is directed to developing known heat exchangers and methods for operating heat exchangers with respect to the described challenges.

The problem is solved using a heat exchanger and a method for operating a heat exchanger having the features as described and claimed herein. Advantageous embodiments are the subject matter of one or more claims.

In one aspect, a heat exchanger for a liquid medium according to the present subject matter includes a first chamber for receiving a liquid medium and a first heat exchanger arrangement arranged in the first chamber. According to the present subject matter, the heat exchanger also includes a second chamber for receiving a liquid medium, a second heat exchanger arrangement arranged in the second chamber, and a first pre-screening device. The first pre-screening device protects the heat exchanger in particular against coarse debris and, as a result, can reduce the corresponding amount of maintenance work required. In addition, due to the integrated pre-screening device, the heat exchanger is recommended as a complete solution for installation in particular in commercial buildings. The first pre-screening device is arranged, for example, on an outer surface of the heat exchanger. The first pre-screening device can in particular be connected to the first chamber and to the second chamber, resulting in a common pre-screening for both chambers. For example, by means of corresponding valves or by means of a Y junction, a decision can be made as to which chamber will be loaded with the liquid medium at the particular point in time. Both chambers can also be loaded with the liquid medium at the same time.

Due to the provision of the first chamber and the second chamber, the heat exchanger can for example be flexibly adapted to different performance requirements. In the event of recovering heat from wastewater, when the wastewater volume is low, for example, only one of the chambers may be used. When the wastewater volume is high, both chambers can be used, preferably in parallel. It is also conceivable to use the chambers in alternation in a batch operation. The different operating options, which result due to the first and the second chamber, are explained in greater detail in the following in connection with the method according to the present subject matter. The integrated first pre-screening device ensures that the amount of maintenance work required is acceptable despite the complicated design of the heat exchanger with the separated chambers.

As indicated above, the liquid medium can in particular be wastewater and/or sewage sludge. The first heat exchanger arrangement and/or the second heat exchanger arrangement can in particular be designed as bundle heat exchangers, plate heat exchangers, and/or spiral heat exchangers. The first heat exchanger arrangement and/or the second heat exchanger arrangement can for example contain a liquid heat transfer medium, in particular water or a water-glycol mixture. The first heat exchanger arrangement and/or the second heat exchanger arrangement can be operated with respect to the liquid medium preferably in the parallel flow mode, the counterflow mode, or the cross flow mode. The first chamber and the second chamber are preferably provided in a common casing structure of the heat exchanger, whereby a compact design of the heat exchanger is achieved.

It is advantageous when the first heat exchanger arrangement and the second heat exchanger arrangement include two separate heat transfer medium circuits or the first heat exchanger arrangement and the second heat exchanger arrangement include a common heat transfer medium circuit. The embodiment with two separate heat transfer medium circuits makes it possible to flexibly adapt the heat exchanger to different operating conditions. This is advantageous in particular during the selective or alternating operation of the first chamber and the second chamber.

The alternative embodiment with a common heat transfer medium circuit allows for a particularly efficient heat transfer, since the entire available heat exchanger surface can be used for one single circuit. As a result, the residual heat can be more efficiently extracted above all with liquid media having a low heat content. In addition, as a result, for example, it is possible to transfer heat from a first liquid medium in the first chamber to a second liquid medium in the second chamber. In a wastewater treatment plant, as a result, for example, heat can be transferred from digested sludge to thin sludge, wherein a higher temperature of the thin sludge during the further processing, in particular during pressing, has proven advantageous.

The first heat exchanger arrangement and the second heat exchanger arrangement preferably have a switching device, by means of which flow can be conducted either in parallel or in series through the two heat exchanger arrangements. The switching device includes, for example, a plurality of valves, which are controlled by means of a control unit.

It is also advantageous when the first heat exchanger arrangement and/or the second heat exchanger arrangement includes a heat exchanger cleaning device. This enables effective cleaning of the heat-transferring surfaces of the heat exchanger arrangements during the operation. Due to the continuous or periodic cleaning, the attachment of debris to the heat transfer surfaces is prevented, whereby the heat transfer can be held continuously at a high level. The heat exchanger cleaning device preferably includes mechanical cleaning elements, which are designed, for example, as brushes and/or scrapers and are guided over the heat transfer surfaces. The mechanical cleaning elements are adapted in particular to a shape of the heat transfer surfaces of the heat exchanger arrangements. For example, in an embodiment of the heat exchanger arrangements as bundle heat exchangers, the mechanical cleaning elements can be at least partially circular.

Alternatively or additionally, the heat exchanger cleaning device can also include a rinsing device, which operates in particular with pressurized water or a cleaning medium. The heat exchanger cleaning device is preferably automated and is activated by means of a control unit according to operating parameters such as the heat transfer capacity or a predetermined time duration.

It is also advantageous when the heat exchanger has a second pre-screening device, wherein the first pre-screening device is connected to the first chamber and the second pre-screening device is connected to the second chamber. This arrangement makes it possible to individually pre-clean the liquid medium for each chamber. A divided pre-screening is advantageous in particular when the first chamber and the second chamber are loaded with different liquid media. The first pre-screening device and the second pre-screening device can in particular be identically designed. It is also conceivable, however, that the pre-screening devices are adapted, for example with regard to a mesh size, to the particular liquid medium provided.

It is particularly advantageous when the first pre-screening device and/or the second pre-screening device includes a perforated plate, in particular having a hole diameter in a range from 3 mm to 10 mm, and/or a screen cleaning device and/or an emergency overflow and/or a screenings return connected to a discharge of the heat exchanger.

The perforated plate makes it possible to effectively separate coarse solids from the fluids. The aforementioned hole diameter range from 3 mm to 10 mm is an advantageous compromise between separation efficiency and flow resistance. The perforated plate is preferably made of corrosion-resistant material, in particular of stainless steel. The perforated plate can be designed to be, for example, exchangeable, in order to adapt the heat exchanger to different requirements or to effectively service the heat exchanger.

The screen cleaning device is used to remove retained screenings from the screen surface, in particular from the above-described perforated plate. As a result, a substantially consistent flow resistance of the pre-screening device(s) can be achieved. The screen cleaning device preferably includes at least one mechanical scraper, which is designed for example as a brush and/or as a scraper element. Alternatively or additionally, the screen cleaning device can also include a rinsing device, which removes the screenings from the screen surface by means of a fluid jet.

When the pre-screening device is clogged, the emergency overflow prevents a backlog of the fluid and thus allows for an uninterrupted and safe operation of the heat exchanger. The emergency overflow is preferably designed as an overflow edge, which is overflown when a critical liquid level is reached. The height of the overflow edge is selected in particular in such a way that a backlog into the supplying line is avoided. Alternatively, the emergency overflow can also be designed, for example, as an automatic valve, which reacts in particular to a pressure and/or to a fluid level in the pre-screening device or in the pre-screening devices. The emergency overflow is preferably designed as an internal emergency overflow, wherein an emergency overflow of the first pre-screening device is connected in particular to the first chamber and an emergency overflow of the second pre-screening device is connected to the second chamber. When there is a common first pre-screening device for both chambers, the emergency overflow can be connected to both chambers or only to the first chamber or to the second chamber.

The screenings return directs the removed screenings into the discharge of the heat exchanger, whereby a separate collection and disposal of the screenings is eliminated. The screenings return is preferably designed as an inclined channel, which transports the screenings by gravity to the discharge. It is also conceivable to rinse the screenings return with an externally supplied rinsing fluid. The screenings return can in particular be connected to the screen cleaning device in such a way that the screenings removed from the screen cleaning device are transported from the screen cleaning device into the screenings return.

It is also extremely advantageous when the first chamber and/or the second chamber has a screw arrangement for separating out solid wastewater components. The screw arrangement makes it possible to continuously separate out and remove solids from the liquid medium in an automated manner during the operation. This is advantageous with high-viscosity media such as sewage sludge. The screw arrangement preferably includes a driven screw shaft on which an auger flight is arranged. The auger flight is made in particular of wear-resistant material such as, in particular, stainless steel. The screw arrangement is preferably arranged in a screw trough, which is mounted in the lower region of the chamber. The removed solids are conveyed through the screw arrangement to a discharge area. The discharge area is in particular hydraulically decoupled from a discharge of the heat exchanger. This can be achieved, for example, by means of a corresponding weir.

It is advantageous when the first chamber and/or the second chamber includes at least one flow baffle plate. The flow baffle plate is used to guide the fluid flow inside the chamber in a targeted manner. Due to the optimized flow guidance, the dwell time of the fluid in the area of the heat exchanger arrangement is increased and thus the heat transfer is improved. In addition, as a result, the separation or sedimentation of suspended solids can be improved, which solids are to settle in particular in the lower areas of the chambers, where they can be removed or conducted away, for example, by means of the described screw arrangement or the described screw arrangements. The flow baffle plates are preferably designed as plates that bring about a defined deflection of the flow. The arrangement of the flow baffle plates is in particular selected in such a way that dead zones are avoided and a uniform flow through the heat exchanger arrangement is achieved. The flow baffle plates can be used, for example, to equalize the flow rate. The flow baffle plates are preferably made of corrosion-resistant material such as, in particular, stainless steel.

It is also advantageous when a partition is present between the first chamber and the second chamber, which is preferably made of plastic. The partition ensures a complete spatial and hydraulic separation of the two chambers. Due to the separation, a mutual influencing of the flow conditions in the chambers can be prevented. The embodiment of the partition made of plastic offers a plurality of advantages. Plastic has high corrosion resistance and is resistant to the media contained in the wastewater. The thermal conductivity of plastic, which is lower in comparison to metal materials, also reduces an undesired heat transfer between the chambers. The partition is preferably designed as a sandwich construction, which includes in particular a core made of foamed plastic and cover layers made of fiber-reinforced plastic. The partition is connected to the chamber walls, for example, by means of a water-tight screw connection or bonding. In certain applications of the heat exchanger, heat transfer between the chambers can be unproblematic. In these cases, the partition can be made, for example, of metal, in particular stainless steel.

It is also advantageous when the heat exchanger includes an external heat source, in particular a heat pump and/or a cogeneration unit. The integration of an external heat source makes it possible to raise the temperature level of the heat transfer medium according to demand. This is advantageous in particular when a liquid medium in a wastewater treatment plant must be brought to a higher temperature that is advantageous for further processing. This can be the case prior to a pressing operation, for example, in the above-described example of the thin sludge. The heat pump uses, for example, the low temperature heat obtained from a first liquid medium in the first chamber as a heat source and raises this to a higher, usable temperature level using electrical energy. A cogeneration unit generates electrical energy and useful heat at the same time by means of combined heat and power generation, whereby a particularly efficient overall operation is achieved. The external heat source is preferably connected to the heat transfer medium circuit of the heat exchanger via a heat transfer device. The use of a cogeneration unit as an external heat source is a possibility above all in a wastewater treatment plant in which a cogeneration unit is already present. The external heat source has in particular a power of at least 100 KW.

It is advantageous when the first heat exchanger arrangement and/or the second heat exchanger arrangement includes a plurality of modules, each of which has a plurality of S-tubes, wherein each module has in particular two rows of S-tubes. This modular design makes it possible to flexibly adapt the heat transfer surface to the particular performance requirements. The division into a plurality of modules also simplifies the service and maintenance, since individual modules can be exchanged as necessary, without the need to disassemble the entire heat exchanger arrangement. The arrangement of the S-tubes in two rows per module ensures a compact design with good accessibility during the assembly of the heat exchanger. The first and the second heat exchanger arrangements are designed as bundle heat exchangers in this case. The S-tubes are preferably made of corrosion-resistant material, in particular of stainless steel. If the heat exchanger arrangements have a heat exchanger cleaning device, this can also have a modular design. A cleaning module with cleaning elements for each tube of the module of the heat exchanger arrangement can be provided, for example, for each module of the heat exchanger arrangements. The cleaning modules preferably move along the tubes of the module.

It is also advantageous when the S-tubes are arranged on different levels of a module, diagonally offset with respect to one another in each case. This offset arrangement brings about a more compact design of each module, wherein, given the same volume, more modules can be arranged in the chamber of the heat exchanger. Due to the diagonal offset of the S-tubes, accessibility for tools, in particular pliers for press fittings, during the assembly of the modules also remains ensured.

Furthermore, it is advantageous when the S-tubes of a module are arranged in at least one frame plate, wherein two tubes arranged one above the other are arranged in each case in a common, in particular bone-shaped, cutout in the frame plate. This arrangement ensures a defined position of the S-tubes and gives the module the required mechanical stability. In addition to having a bone shape, the cutouts can also be, for example, rectangular, polygonal, and/or designed as an elongate hole. The cutout makes it possible for the liquid medium to flow through the frame plate. As a result, the likelihood of attachments on the frame plate decreases. In addition, as a result, an improved flow through the chambers of the heat exchanger is provided, even when the modules are arranged have only small intermediate spaces. The shape of the cutout is preferably designed in such a way that the tubes are held without play and, at the same time, simple assembly is possible. The frame plate is made in particular of corrosion-resistant material. One module in each case is arranged in particular in at least two frame plates. It is also conceivable to provide separate cutouts in the frame plate, which are used exclusively to improve the flow through the frame plate.

The method according to the present subject matter is suitable for operating a heat exchanger, in particular according to the preceding description, wherein the heat exchanger includes a first chamber in which a first heat exchanger arrangement is arranged. The heat exchanger also includes a second chamber, in which a second heat exchanger arrangement is arranged, and at least one first pre-screening device. In the method, a heat transfer medium flows through the first heat exchanger arrangement and/or the second heat exchanger arrangement. A liquid medium is pre-screened by the first pre-screening device and the first chamber and/or the second chamber is loaded with the pre-screened liquid medium. Due to the pre-screening of the liquid medium, a soiling of the heat exchanger arrangement is prevented and thus, for example, an efficient heat transfer is continuously ensured and the likelihood of clogging is reduced. The separated embodiment of the chambers allows for a flexible operation in which the heat exchanger arrangements can be operated individually or jointly according to need. As described above, the liquid medium is preferably wastewater or sewage sludge, the heat content of which is recovered by the heat exchanger.

For the method, it is advantageous when screenings of the first pre-screening device are conveyed via a screenings return to a discharge of the heat exchanger. As a result, the screenings separated out in the pre-screening device are automatically removed from the system. The return of the screenings to the discharge allows for continuous operation without manual interventions to dispose of screenings. In addition, clogging of the pre-screening device, in particular in interaction with a screen cleaning device, is prevented. The screenings return is preferably carried out by gravity, wherein the screenings are transported to the discharge via an inclined chute or a channel. The screenings return is designed in particular in such a way that clogging due to the returned screenings is avoided. The transport of the screenings can also be assisted, for example, by a mechanical conveying device or a rinsing device.

Furthermore, it is advantageous when the heat exchanger is operated either in a first operating mode or in a second operating mode, wherein, in the first operating mode, the first heat exchanger arrangement and the second heat exchanger arrangement include two separate heat transfer medium circuits, and in the second operating mode, the first heat exchanger arrangement and the second heat exchanger arrangement include a common heat transfer medium circuit. The at least two operating modes allow for a number of possible applications for the heat exchanger. Depending on the demand, the chambers can be operated individually or jointly. The heat transfer surface of the heat exchanger arrangements can be flexibly adapted to the available heat content.

In addition, heat can be transferred from a first liquid medium to a second liquid medium. The switch between the operating modes is preferably carried out by motor-operated valves, which are controlled by a higher-level controller. The developments of the method described herein can also be of significance in particular regardless of the remaining features of the present subject matter.

In this context, it is advantageous when, in the first operating mode, the first chamber and the second chamber are loaded in alternation with a liquid medium in a batch operation. This alternating batch operation allows for a continuous heat transfer with simultaneous optimization of the dwell time of the liquid medium in the chambers. This is advantageous in particular when a liquid medium must be cooled in a wastewater treatment plant to a desired target temperature for further processing. While one chamber is loaded with fresh medium, the heat transfer up to the desired temperature level can be carried out in the other chamber. The switch between the chambers is preferably carried out automatically by a control unit which coordinates the filling and emptying processes. The dwell time of the liquid medium in the chambers is in particular selected in such a way that an optimal heat transfer is achieved. The controller also takes into account, for example, parameters such as the input temperature of the liquid medium or the desired target temperature.

It is also advantageous when, in the second operating mode, heat is transferred from a first liquid medium in the first chamber to a second liquid medium in the second chamber. This type of operating method allows for a direct heat transfer between two different liquid media via the coupled heat exchanger arrangements. Due to the common heat transfer medium circuit, the thermal energy is transferred from the first liquid medium initially to the heat transfer medium and from this to the second liquid medium. The temperature difference between the liquid media can preferably be utilized in an optimal manner by appropriately selecting the flow direction of the heat transfer medium. The flow volumes of the liquid media are in particular matched to one another in such a way that the highest possible efficiency of heat transfer is achieved. In this case, the heat exchanger has in particular a second pre-screening device, wherein the first pre-screening device is associated with the first chamber and the second pre-screening device is associated with the second chamber. As a result, the chambers can be filled at the same time or operated in a flow-through mode without the liquid media becoming mixed.

It is also extremely advantageous when, in the first operating mode or in the second operating mode, the first chamber and the second chamber are loaded in parallel with the same liquid medium. This parallel loading makes it possible to increase the overall throughput with a consistent flow rate into the individual chambers. Due to the division of the volumetric flow to both chambers, uniform hydraulic loading is achieved. The parallel loading is preferably designed in such a way that a uniform distribution of the liquid medium to both chambers results. The distribution is carried out, for example, by means of the common first pre-screening device, which is connected to the first chamber and to the second chamber in particular with a Y junction. In the first operating mode, the heat transferred into the separate heat transfer medium circuits can be used for different purposes. In the second operating mode, the first heat exchanger arrangement and the second heat exchanger arrangement can be connected, for example, in series. Given a low heat content of the liquid medium, the transfer surface advantageously increases as a result. Alternatively, in the second operating mode, the first heat exchanger arrangement and the second heat exchanger arrangement could be connected, for example, in parallel, wherein the heat transfer medium circuit splits to both heat exchanger arrangements and then coalesces once again. As a result, a higher throughput of the heat transfer medium with a consistent transfer efficiency can be achieved.

It is advantageous when, in the first operating mode, only one of the first chamber or the second chamber is loaded with a liquid medium. This selective loading allows for operation according to demand at low flow volumes of the liquid medium. The operation of only one chamber results in a reduction of the energy expenditure, since flow takes place only through the heat transfer surface that is actually needed. The chamber that is not loaded can preferably be serviced or cleaned during this time. The switch between the chambers is carried out, for example, according to operating parameters such as the required heat transfer capacity or a maintenance plan.

### BRIEF DESCRIPTION OF THE FIGURES

Further advantages of the present subject matter are described in the following exemplary embodiments, wherein:

FIG. 1 shows a schematic side view of a first exemplary embodiment of the heat exchanger according to the present subject matter,

FIG. 2 shows a schematic front view of the first exemplary embodiment of the heat exchanger according to the present subject matter,

FIG. 3 shows a schematic side view of a second exemplary embodiment of the heat exchanger according to the present subject matter,

FIG. 4 shows a schematic front view of the second exemplary embodiment of the heat exchanger according to the present subject matter with a frame plate represented separately,

FIG. 5 shows a schematic front view of a third exemplary embodiment of the heat exchanger according to the present subject matter,

FIG. 6 shows a schematic flow diagram of a first exemplary embodiment of the method according to the present subject matter,

FIG. 7 shows a schematic flow diagram of a second exemplary embodiment of the method according to the present subject matter,

FIG. 8 shows a schematic flow diagram of a third exemplary embodiment of the method according to the present subject matter,

FIG. 9 shows a schematic flow diagram of a fourth exemplary embodiment of the method according to the present subject matter, and

FIG. 10 shows a schematic flow diagram of a fifth exemplary embodiment of the method according to the present subject matter.

### DETAILED DESCRIPTION OF THE FIGURES

In the following description of the figures, the same reference characters are used for identical and/or at least comparable features in the different figures. The individual features, their embodiment and/or mode of operation are usually only explained in detail when they are first mentioned. If individual features are not explained in detail again, their embodiment and/or mode of operation corresponds to the embodiment and the mode of operation of the features having the same effect or the same name that have already been described.

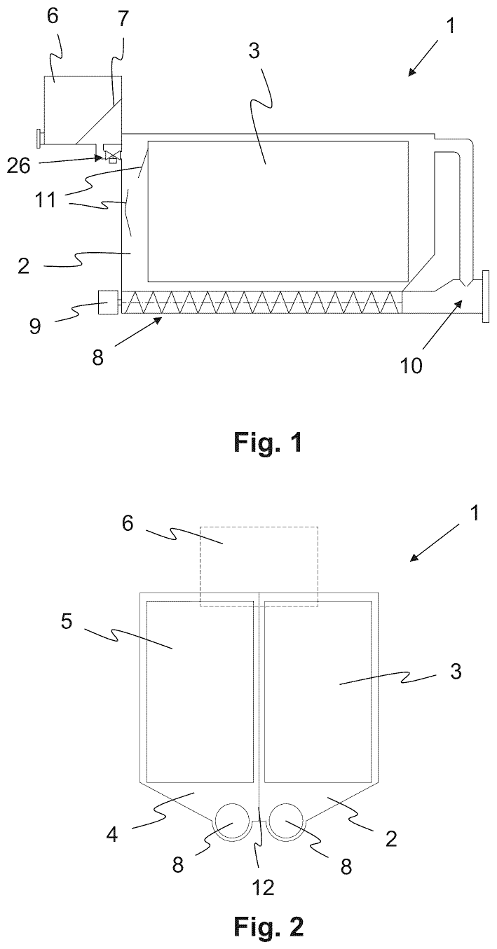

FIG. 1 shows a side view of a first exemplary embodiment of the heat exchanger 1 according to the present subject matter, which has a first chamber 2 for receiving a liquid medium. A first heat exchanger arrangement 3 is arranged in the first chamber 2. The heat exchanger 1 also includes a second chamber 4 (not shown in this view) having a second heat exchanger arrangement 5 (see FIG. 2). This embodiment of the heat exchanger 1 makes it possible to flexibly adapt the operating states of the heat exchanger 1 to different requirements.

The heat exchanger 1 also includes a first pre-screening device 6, with which coarse debris is separated out of the liquid medium by screening, wherein the liquid medium is supplied to the first chamber 2 and/or to the second chamber 4. As a result, the likelihood of attachments to the first and second heat exchanger arrangements 3, 5, which reduce the transfer efficiency, and the likelihood of the heat exchanger 1 becoming clogged are reduced. A valve 26 is indicated between the pre-screening device 6 and the first chamber 2, which can regulate the inflow of the liquid medium to the first chamber 2 (see more detailed explanations for FIGS. 6 through 10).

The first screening device 6 includes, in this example, a perforated plate 7. The perforated plate 7 can in particular have a hole diameter in the range from 3 mm to 10 mm, whereby an advantageous compromise between separation efficiency and flow resistance is achieved. The perforated plate 7 is made in particular of corrosion-resistant material, in particular stainless steel, and is exchangeable in order to adapt the heat exchanger 1 to different requirements or to effectively service the heat exchanger 1.

In the lower area of the first chamber 2 of the heat exchanger 1, a screw arrangement 8 is provided for separating out solid components of the liquid medium, wherein the screw arrangement is driven, for example, by means of a motor 9. The screw arrangement 8 includes, for example, a driven screw shaft with an auger flight arranged thereon, wherein the auger flight is made of wear-resistant material, in particular stainless steel. The screw arrangement 8 is arranged in particular in a screw trough and conveys the separated-out solids to a discharge area. A hydraulic separation of the discharge area and a discharge of the heat exchanger 1 or a discharge of the first chamber 2 and/or of the second chamber 4 is ensured in particular by means of a weir 10.

The first chamber 2 has, in this exemplary embodiment, a plurality of flow baffle plates 11, which are made, for example, of plates and bring about a defined deflection of the flow. In addition or alternatively, the second chamber 4 can also have corresponding flow baffle plates 11. The flow baffle plates 11 improve, for example, the separation or sedimentation of suspended solids, which settle in particular in the lower areas of the first and second chambers 2, 4 and can be removed by means of the screw arrangement 8.

FIG. 2 shows a front view of the heat exchanger 1 according to the present subject matter in the embodiment from FIG. 1, wherein the spatial arrangement of the first and the second chamber 2, 4 becomes apparent. The first and second chambers 2, 4 are provided in particular in a common casing structure, whereby a compact design of the heat exchanger 1 is achieved. The chambers are separated from one another by a partition 12, which is preferably made of plastic. The partition 12 ensures a complete spatial and hydraulic separation of the two chambers 2, 4. The embodiment of the partition 12 made of plastic has lower thermal conductivity in comparison to metal materials and thus reduces an undesired heat transfer between the first and second chambers 2, 4 and also has high corrosion resistance with respect to the liquid media contained in the first and second chambers 2, 4, which can in particular be wastewater or sewage sludge.

In this view, it is apparent that, in this exemplary embodiment, the first chamber 2 and the second chamber 4 have screw arrangements 8 which allow for continuous separation and automatic removal of solids from the liquid media during the operation or during downtimes of the heat exchanger 1. This is advantageous with high-viscosity media such as sewage sludge.

The first pre-screening device 6 is, in this exemplary embodiment, provided for both the first and second chambers 2, 4 together. The distribution of the pre-cleaned liquid medium to the chambers 2, 4 can be controlled, for example, by valves 26 (see FIG. 6), which are not represented in this figure, or a Y junction, whereby a decision can be made as to which chamber will be loaded with the liquid medium at the particular point in time. Both chambers can also be loaded with the liquid medium at the same time, whereby a flexible adaptation to different performance requirements is possible.

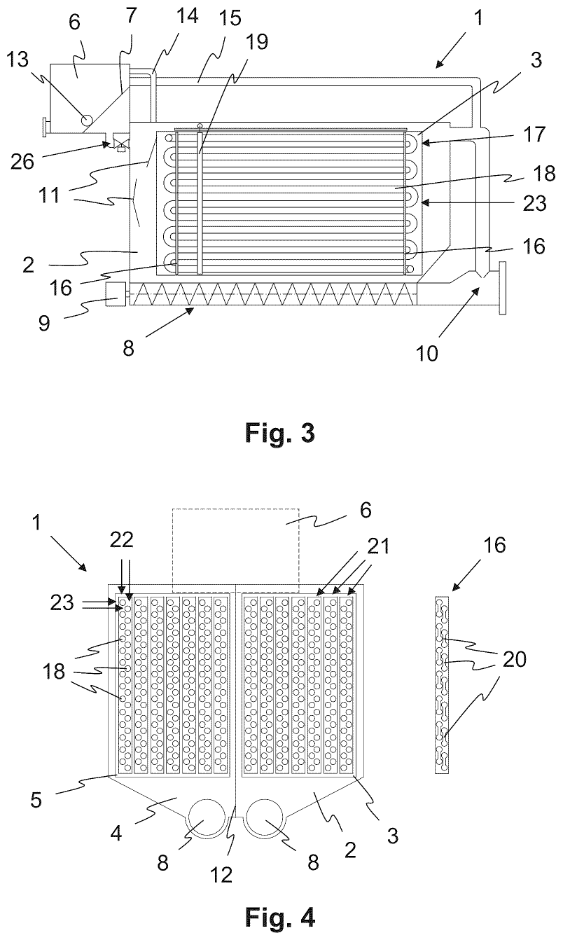

FIG. 3 shows a side view of a second exemplary embodiment of the heat exchanger 1 according to the present subject matter, in which in particular a possible embodiment of the first heat exchanger arrangement 3 is apparent. The first chamber 2 is designed as described above, while the first heat exchanger arrangement 3 is designed, in this exemplary embodiment, as a bundle heat exchanger. The first heat exchanger arrangement 3 includes a plurality of S-tubes 17. The S-tubes 17 consist of individual tubes 18 in different levels 23.

The S-tubes 17 are, in this exemplary embodiment, each arranged in two frame plates 16, which are represented in greater detail in FIG. 4.

In this exemplary embodiment, the first pre-screening device 6 includes a screen cleaning device 13 and a screenings return 15. The screen cleaning device 13 prevents clogging of the first pre-screening device 6 and ensures a substantially consistent flow resistance. The screenings captured by the screen cleaning device 13 can be transferred, for example, directly to the screenings return 15, wherein the screenings return 15 transports the screenings to a discharge of the heat exchanger 1. The first pre-screening device 6 also includes, in this exemplary embodiment, an emergency overflow 14. When the pre-screening device 6 is possibly clogged, the emergency overflow 14 prevents a backlog of the liquid medium and allows for an uninterrupted, safe operation of the heat exchanger 1. The emergency overflow 14 can preferably be connected to the first chamber 2 and/or to the second chamber 4.

The first heat exchanger arrangement 3 is equipped with a heat exchanger cleaning device 19, which allows for effective cleaning of the heat-transferring surfaces, in particular of the tubes 18, during the operation. Due to the continuous or periodic cleaning, the attachment of debris is prevented, whereby the heat transfer can be held continuously at a high level. For example, the heat exchanger cleaning device 19 travels along the tubes 18 and scrapes debris from the tubes. In addition or alternatively, the second heat exchanger arrangement 5 can have a heat exchanger cleaning device 19.

As described above, the first heat exchanger arrangement 3 in this example is designed as a bundle heat exchanger and, in particular, a heat transfer medium flows through same, wherein the heat transfer medium used is, for example, water or a water-glycol mixture. The first heat exchanger arrangement 3 is used, for example with respect to the liquid medium, in the counterflow mode.

FIG. 4 shows a front view of the second exemplary embodiment of the heat exchanger 1, wherein a frame plate 16 is represented separately on the right side. The representation illustrates the modular design of the heat exchanger arrangements 3, 5 and the structural design of the frame plate 16. The first heat exchanger arrangement 3 and the second heat exchanger arrangement 5, which, as described above, are designed as bundle heat exchangers, are arranged in the first and second chambers 2, 4. The heat exchanger arrangements 3, 5 consist of multiple modules 21, wherein one module in each case has two rows 22 of S-tubes 17 on different levels 23.

The tubes 18 of the heat exchanger arrangements 3, 5 are arranged diagonally offset with respect to one another in the different levels 23. This offset arrangement brings about a more compact design, wherein the diagonal offset of the S-tubes 17 ensures accessibility for tools, in particular pliers for press fittings, during the assembly.

The frame plate 16 represented separately on the right includes in particular bone-shaped cutouts 20, in each of which two tubes 18 arranged one above the other are held without play. The shape of the cutouts 20 is designed in such a way that simple assembly is possible and, at the same time, a flow of the liquid medium through the frame plate 16 is ensured. The frame plate 16 is made, for example, of corrosion-resistant material, wherein each module 21 is arranged in particular in at least two frame plates 16. The bone shape of the cutouts 20 is represented here merely by way of example. As described above, other shapes of the cutouts 20 are conceivable.

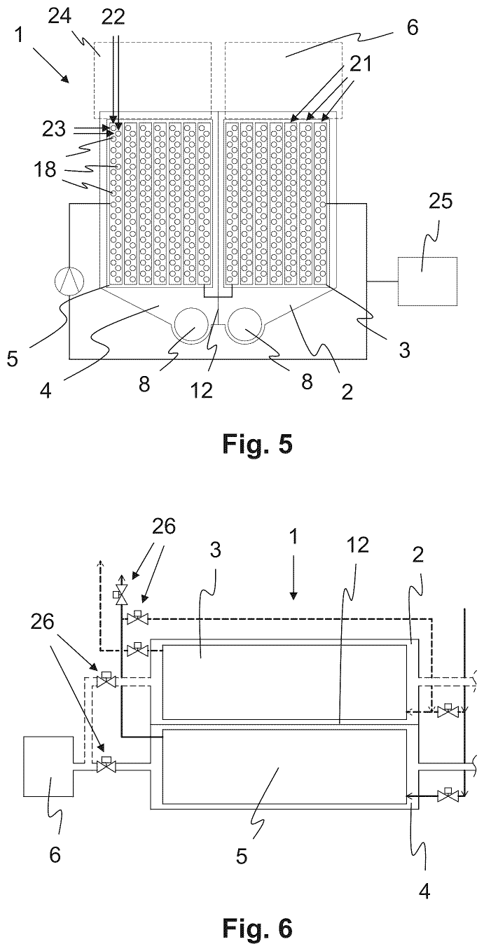

FIG. 5 shows a front view of a third exemplary embodiment of the heat exchanger 1 according to the present subject matter, which, in comparison with the previous exemplary embodiments, is expanded with a second pre-screening device 24 and an external heat source 25. The first pre-screening device 6 and the second pre-screening device 24 are arranged in the upper area of the heat exchanger 1, wherein the first pre-screening device 6 is connected, for example, to the first chamber 2 and the second pre-screening device 24 is connected to the second chamber 4. This divided pre-screening makes it possible to individually pre-clean the liquid medium for each chamber 2, 4. This is particularly advantageous when the first chamber 2 and the second chamber 4 are loaded with different liquid media.

The external heat source 25 makes it possible to raise the temperature level of the heat transfer medium according to demand. The external heat source 25 can be designed as a heat pump and/or a cogeneration unit and has in particular a power of at least 100 kW.

The heat transfer medium circuits of the first heat exchanger arrangement 3 and of the second heat exchanger arrangement 5 are interconnected in this exemplary embodiment, such that, in particular, thermal energy can be transferred from a first liquid medium in the first chamber 2 to a second liquid medium in the second chamber 4, or vice versa, depending on the flow direction of the heat transfer medium.

FIG. 6 shows a flow diagram of a first exemplary embodiment of the method according to the present subject matter for operating the heat exchanger 1, which has the first chamber 2 with the first heat exchanger arrangement 3 and the second chamber 4 with the second heat exchanger arrangement 5. In this figure and the following figures, active lines are represented using solid lines and inactive lines are represented using dashed lines. Although the first pre-screening device 6 is represented as being offset in the flow diagram, it is nevertheless an integrated component of the heat exchanger 1.

In the exemplary embodiment in FIG. 6, the heat exchanger 1 is operated in the first operating mode in which the first heat exchanger arrangement 3 and the second heat exchanger arrangement 5 include two separate heat transfer medium circuits. The control of the heat transfer medium circuits and the supply of liquid media into the first and second chambers 2, 4 is carried out, for example, via a plurality of valves 26, which are controlled in particular by a higher-level control unit (not represented).

The example represents a use of the heat exchanger 1 with a low volume of the liquid medium, in particular wastewater or sewage sludge. The liquid medium is initially directed through the first pre-screening device 6. The valves 26 are switched in such a way that only the second chamber 4 is loaded with the pre-cleaned liquid medium, whereas the first chamber 2 is not loaded. Accordingly, in addition, only the second heat exchanger arrangement 5 is active. This selective loading allows for operation according to demand at low flow volumes of the liquid medium. The operation of only the second chamber 4 results in a reduction of the energy expenditure, since flow takes place only through the heat transfer surface that is actually needed.

The first chamber 2, which is not loaded, can be, for example, serviced or cleaned during this time. The switch between the first and second chambers 2, 4 is carried out according to operating parameters such as the required heat transfer capacity, a maintenance plan, and/or the anticipated volumetric flow of the liquid medium.

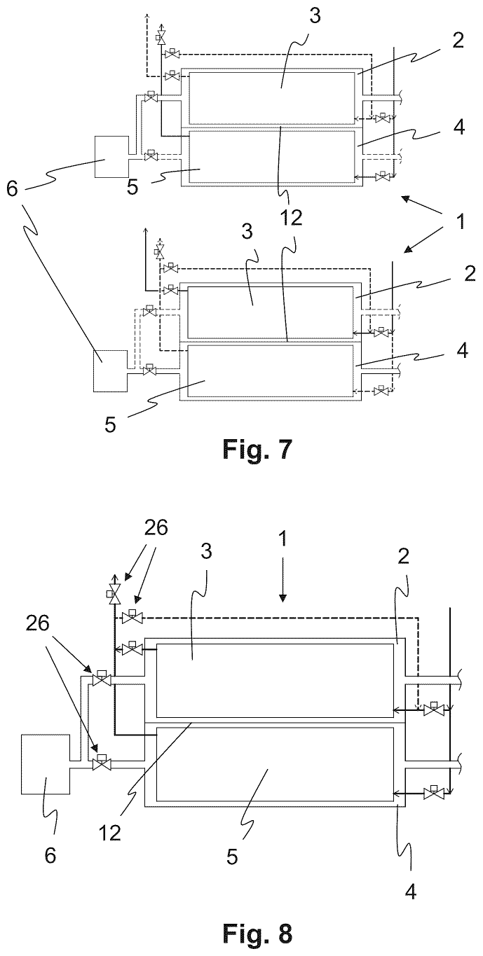

FIG. 7 shows a flow diagram of a second exemplary embodiment of the method according to the present subject matter for operating the heat exchanger 1, in which the first chamber 2 and the second chamber 4 are loaded in alternation with a liquid medium in a batch operation. The first and second heat exchanger arrangements 3, 5 are also operated with separate heat transfer medium circuits in this case.

In the upper part of FIG. 7, the state is represented, in which the first chamber 2 is filled with fresh liquid medium, which has been pre-cleaned by the first pre-screening device 6 and supplied to the first chamber 2. At the same time, in the second chamber 4, the heat transfer takes place from the liquid media already located there to the second heat exchanger arrangement 5 up to the desired temperature level. The lower part of FIG. 7 shows the alternating state in which the second chamber 4 is filled with fresh, pre-cleaned liquid medium, whereas the heat transfer takes place in the first chamber 2.

This alternating batch operation allows for a continuous heat transfer with simultaneous optimization of the dwell time of the liquid medium in the first and second chambers 2, 4. This is advantageous in particular when a liquid medium must be cooled in a wastewater treatment plant to a desired target temperature for further processing. The switch between the chambers is carried out, for example, automatically by a control unit (not represented) which coordinates the filling and emptying processes. The dwell time of the liquid medium in the chambers is selected in such a way that an optimal heat transfer is achieved, wherein the controller takes into account parameters such as the input temperature of the liquid medium or the desired target temperature.

FIG. 8 shows a flow diagram of a third exemplary embodiment of the method according to the present subject matter for operating the heat exchanger 1, in which the first chamber 2 and the second chamber 4 are loaded in parallel with the same liquid medium and the heat exchanger arrangements 3, 5 are connected in a parallel circuit.

The heat exchanger 1 is operated in the second operating mode in this case, wherein the first heat exchanger arrangement 3 and the second heat exchanger arrangement 5 form a common heat transfer medium circuit by appropriately switching the valves 26. The heat transfer medium circuit splits to both heat exchanger arrangements 3, 5 and then coalesces once again. As a result, a higher throughput of the heat transfer medium with a consistent transfer efficiency can be achieved.

The liquid medium pre-cleaned by means of the first pre-screening device 6 is uniformly distributed to both the first and second chambers 2, 4 via corresponding valves 26. This parallel loading makes it possible to increase the overall throughput with a consistent flow rate into the individual chambers 2, 4. Due to the division of the volumetric flow to both chambers 2, 4, uniform hydraulic loading is achieved.

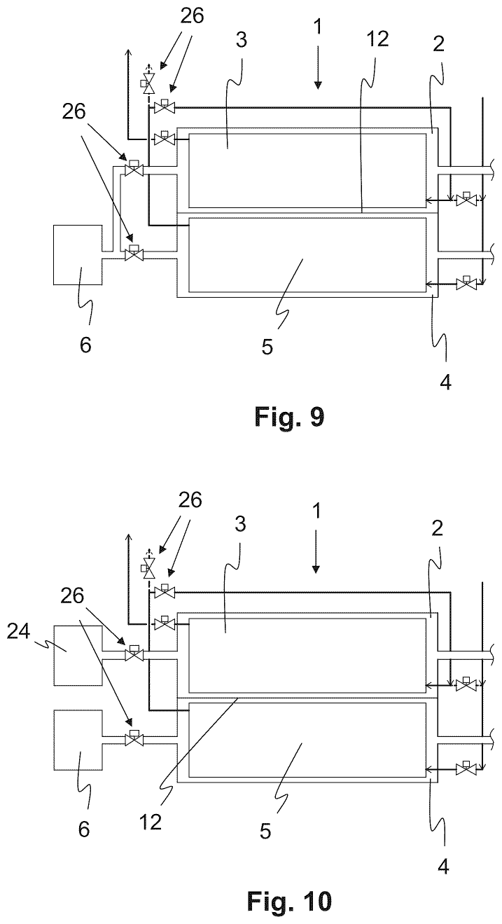

FIG. 9 shows a flow diagram of a fourth exemplary embodiment of the method according to the present subject matter for operating the heat exchanger 1, in which the first heat exchanger arrangement 3 and the second heat exchanger arrangement 5 are operated in a series circuit, whereas the first chamber 2 and the second chamber 4 are loaded in parallel with liquid medium.

The heat exchanger 1 is operated in this case in the second operating mode with a common heat transfer medium circuit. By appropriately switching the valves 26, the heat transfer medium flows through the first heat exchanger arrangement 3 and the second heat exchanger arrangement 5 in series. This series circuit is advantageous in particular with liquid media having a low heat content, since, as a result, the available heat transfer surface increases and the residual heat can be more efficiently extracted.

The liquid medium pre-cleaned by the first pre-screening device 6 is in turn uniformly distributed to the first chamber 2 and the second chamber 4.

FIG. 10 shows a flow diagram of a fifth exemplary embodiment of the method according to the present subject matter for operating the heat exchanger 1, in which heat is transferred from a liquid medium in the second chamber 4 to another liquid medium in the first chamber 2.

The heat exchanger 1 is operated in the second operating mode, wherein the first heat exchanger arrangement 3 and the second heat exchanger arrangement 5 form a common heat transfer medium circuit which is connected in series by appropriately switching the valves 26. This operating method allows for an indirect heat transfer between two different liquid media via the coupled first and second heat exchanger arrangements 3, 5.

The first pre-screening device 6 and the second pre-screening device 24 are associated separately with the chambers 2, 4, whereby an individual pre-cleaning of the different liquid media is made possible. This is particularly advantageous since the first chamber 2 and the second chamber 4 are loaded with different liquid media, which have, for example, different densities or solids concentrations.

### LIST OF REFERENCE CHARACTERS

1 heat exchanger
2 first chamber
3 first heat exchanger arrangement
4 second chamber
5 second heat exchanger arrangement
6 first pre-screening device
7 perforated plate
8 screw arrangement
9 motor
10 weir
11 flow baffle plate
12 partition
13 screen cleaning device
14 emergency overflow
15 screenings return
16 frame plate
17 S-tube
18 tube
19 heat exchanger cleaning device
20 cutout
21 module
22 row
23 level
24 second pre-screening device
25 heat source
26 valve

1-19. (canceled)

20. A heat exchanger for a liquid medium, comprising
a first chamber for receiving liquid medium,
a first heat exchanger arrangement arranged in the first chamber, a second chamber for receiving liquid medium,
a second heat exchanger arrangement arranged in the second chamber, and a first pre-screening device.

21. The heat exchanger of claim 20, wherein the first heat exchanger arrangement and the second heat exchanger arrangement include two separate heat transfer medium circuits, or
the first heat exchanger arrangement and the second heat exchanger arrangement include a common heat transfer medium circuit.

22. The heat exchanger of claim 20, wherein the first heat exchanger arrangement and/or the second heat exchanger arrangement include a heat exchanger cleaning device.

23. The heat exchanger of claim 20, further comprising a second pre-screening device, wherein the first pre-screening device is connected to the first chamber and the second pre-screening device is connected to the second chamber.

24. The heat exchanger of claim 23, wherein the first pre-screening device and/or the second pre-screening device includes a perforated plate, a screen cleaning device, an emergency overflow and/or a screenings return connected to a discharge of the heat exchanger.

25. The heat exchanger of claim 20, wherein the first chamber and/or the second chamber has a screw arrangement for separating out solid components.

26. The heat exchanger of claim 20, wherein the first chamber and/or the second chamber includes at least one flow baffle plate.

27. The heat exchanger of claim 20, wherein a partition is present between the first chamber and the second chamber.

28. The heat exchanger of claim 20, further comprising an external heat source.

29. The heat exchanger of claim 20, wherein:
the first heat exchanger arrangement and/or the second heat exchanger arrangement includes multiple modules each of which has a plurality of S-tubes, and
each module has rows of S-tubes.

30. The heat exchanger of claim 29, wherein the S-tubes are arranged on different levels of each module, diagonally offset with respect to one another.

31. The heat exchanger of claim 29, wherein the S-tubes of each module are arranged in at least one frame plate, wherein two tubes arranged one above the other in each case are arranged in a common cutout of the frame plate.

32. A method for operating a heat exchanger comprising a first chamber in which a first heat exchanger arrangement is arranged, a second chamber in which a second heat exchanger arrangement is arranged, and at least one first pre-screening device, wherein a heat transfer medium flows through the first heat exchanger arrangement and/or the second heat exchanger arrangement, the method comprising:
pre-screening a liquid medium by the first pre-screening device, and loading the first chamber and/or the second chamber with the pre-screened liquid medium.

33. The method of claim 32, wherein screenings of the first pre-screening device are guided via a screenings return to a discharge of the heat exchanger.

34. The method of claim 32, wherein:
the heat exchanger is operated either in a first operating mode or in a second operating mode,
in the first operating mode, the first heat exchanger arrangement and the second heat exchanger arrangement include two separate heat transfer medium circuits, and
in the second operating mode, the first heat exchanger arrangement and the second heat exchanger arrangement include a common heat transfer medium circuit.

35. The method of claim 34, wherein, in the first operating mode, the first chamber and the second chamber are loaded in alternation with the pre-screened liquid medium in a batch operation.

36. The method of claim 34, wherein:
the pre-screened liquid medium comprises a first liquid medium loaded in the first chamber, and a second liquid medium loaded in the second chamber, and
in the second operating mode, heat from the first liquid medium in the first chamber is transferred to the second liquid medium in the second chamber.

37. The method of claim 34, wherein, in the first operating mode or in the second operating mode, the first chamber and the second chamber are loaded in parallel with the same pre-screened liquid medium.

38. The method of claim 34, wherein, in the first operating mode, only one of the first or the second chamber is loaded with the pre-screened liquid medium.
